(19) United States
(12) Patent Application Publication
(10) Pub. No.: US 2024/0340957 A1
(43) Pub. Date: Oct. 10, 2024

(54) COMMUNICATION APPARATUS, CONTROL METHOD, AND COMPUTER-READABLE STORAGE MEDIUM

(71) Applicant: CANON KABUSHIKI KAISHA, Tokyo (JP)

(72) Inventor: EIGORO INA, Kanagawa (JP)

(21) Appl. No.: 18/745,282

(22) Filed: Jun. 17, 2024

Related U.S. Application Data
(63) Continuation of application No. PCT/JP2022/040367, filed on Oct. 28, 2022.

(30) Foreign Application Priority Data
Dec. 17, 2021 (JP) 2021-205465

(51) Int. Cl. H04W 74/0816; H04W 76/15; H04W 84/12

(52) U.S. Cl. CPC H04W 74/0816; H04W 76/15; H04W 84/12

(57) ABSTRACT

A communication apparatus for performing communication in accordance with an IEEE 802.11 series standard executes predetermined communication with a partner apparatus of the communication by aggregating spatial streams usable by the partner apparatus in each of a plurality of links to a first link among the plurality of links, specifies a communication status in a second link different from the first link among the plurality of links while the predetermined communication is executed in the first link, and transmits a predetermined notification to the partner apparatus based on a fact that the communication status in which the partner apparatus can transmit a signal in the second link is specified at an end of the predetermined communication in the first link.

### CROSS-REFERENCE TO RELATED APPLICATIONS

This application is a Continuation of International Patent Application No. PCT/JP2022/040367, filed Oct. 28, 2022, which claims the benefit of Japanese Patent Application No. 2021-205465, filed Dec. 17, 2021, both of which are hereby incorporated by reference herein in their entireties.

### BACKGROUND OF THE INVENTION

### Field of the Invention

The present invention relates to a technique for improving the efficiency of wireless communication.

### Background Art

As communication standards concerning a wireless LAN (Wireless Local Area Network), IEEE (Institute of Electrical and Electronics Engineers) 802.11 standards are known. The IEEE 802.11 standards are series standards including IEEE 802.11a/b/g/n/ac/ax standards. The IEEE 802.11ax standard as the latest standard of the IEEE 802.11 series standards enables use of OFDMA (Orthogonal Frequency-Division Multiple Access) and implements peak throughput of up to 9.6 gigabits per second (see Japanese Patent Laid-Open No. 2018-050133).

Presently, to further improve the throughput and the latency of communication, an IEEE 802.11be standard has been defined as a new standard of the IEEE 802.11 series standards. In the IEEE 802.11be standard, multi-link communication in which one access point (AP) establishes a plurality of radio links with one station (STA) to perform communication has been examined. In multi-link communication, for example, an AP establishes connections with an STA using a plurality of frequency channels in the 2.4-, 5-, or 6-GHz band, and communicates with the STA using the frequency channels simultaneously. In the IEEE 802.11be standard, introducing Enhanced Multi-Link Multi-Radio (EMLMR) has been examined, as described in IEEE 802.11-21/0774r05, Resolution for CIDs related to EMLMR (CC34)-Part 2. In EMLMR, spatial streams usable in some of a plurality of links established in multi-link communication are temporarily aggregated to a specific link to increase the number of spatial streams in the link, thereby implementing efficient communication.

When the number of spatial streams in a specific link is temporarily increased using EMLMR, the number of spatial streams in another link decreases while the operation is performed. In this case, for example, when the number of reception spatial streams is changed, there are temporarily no spatial streams to be used in some links, and a communication apparatus cannot receive signals using frequency channels corresponding to the links. As a result, the communication apparatus cannot receive a control frame transmitted by another communication apparatus, thereby lowering the effect of improvement in efficiency of EMLMR communication.

### SUMMARY OF THE INVENTION

The present invention provides a technique of enabling efficient communication using a plurality of spatial streams.

According to one aspect of the present invention, there is provided a communication apparatus for performing communication in accordance with an IEEE 802.11 series standard, comprising: a communication unit configured to execute predetermined communication with a partner apparatus of the communication by aggregating spatial streams usable by the partner apparatus in each of a plurality of links to a first link among the plurality of links; a specifying unit configured to specify a communication status in a second link different from the first link among the plurality of links while the predetermined communication is executed in the first link; and a notification unit configured to transmit a predetermined notification to the partner apparatus based on a fact that the communication status in which the partner apparatus can transmit a signal in the second link is specified at an end of the predetermined communication in the first link.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view showing an example of a network configuration.

FIG. 2 is a block diagram showing an example of the hardware arrangement of a communication apparatus.

FIG. 3 is a block diagram showing an example of the functional arrangement of the communication apparatus.

FIG. 4 is a block diagram for generally explaining multi-link communication.

FIG. 5A is a view showing an example of an information element to be transmitted/received.

FIG. 5B is a view showing an example of the information element to be transmitted/received.

FIG. 6 is a timing chart showing an example of the procedure of communication.

FIG. 7 is a flowchart illustrating an example of the procedure of processing executed by an AP MLD.

FIG. 8 is a flowchart illustrating an example of the procedure of processing executed by a Non-AP MLD.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### (Network Configuration)

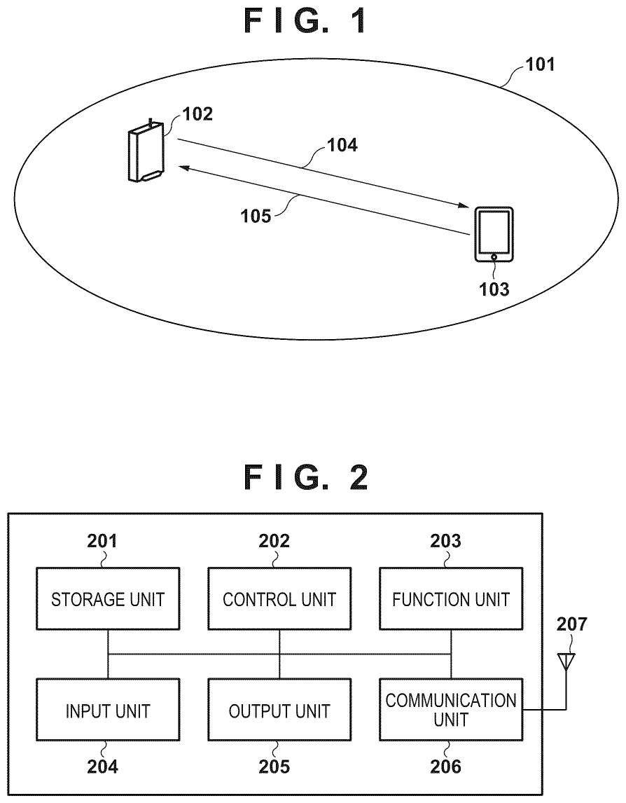

FIG. 1 shows an example of the configuration of a network 101 according to this embodiment. The network 101 includes a plurality of communication apparatuses. Each of the plurality of communication apparatuses can perform communication in a wireless local area network (LAN) complying with the IEEE (Institute of Electrical and Electronics Engineers) 802.11 series standards. Each communication apparatus according to this embodiment supports the IEEE 802.11be (EHT (Extremely/Extreme High Throughput)) standard, and can execute wireless communication complying with this standard. Note that each communication apparatus can operate in accordance with other IEEE 802.11 standards (for example, at least one of the IEEE 802.11a/b/g/n/ac/ax standards).

Each communication apparatus is configured to execute communication complying with the IEEE 802.11 series standard in the frequency bands of the 2.4-, 5-, and 6-GHz bands. Note that the frequency bands usable by each communication apparatus are not limited to them and, for example, a different frequency band such as the 60-GHz band may be used. Each communication apparatus can perform communication using frequency bandwidths of 20 MHz, 40 MHz, 80 MHz, 160 MHz, and 320 MHz. Note that this is merely an example, and each communication apparatus may be configured to use other frequency bandwidths of, for example, 240 MHz and 4 MHz. If a usable frequency bandwidth is newly defined in the IEEE 802.11 series standard, each communication apparatus may be configured to use the frequency bandwidth. Note that the IEEE 802.11 series standard defines a “frequency channel”, and the communication apparatus complying with the standard can execute wireless communication using the frequency channel. In the IEEE 802.11 series standards, a plurality of frequency channels are defined in each of the frequency bands of the 2.4-, 5-, and 6-GHz bands. Furthermore, in the IEEE 802.11 series standards, the bandwidth of each frequency channel is defined as 20 MHz in each frequency band other than the 60-GHz band. Note that by combining (bonding) the adjacent frequency channels, a bandwidth of 40 MHz or more can be used in one frequency channel. Note also that in the 60-GHz band, the bandwidth of each frequency channel is defined as 2.16 GHz.

The plurality of communication apparatuses according to this embodiment are configured to execute multi-link communication in which one access point (AP) establishes a plurality of radio links with one station (STA) to perform communication. Each communication apparatus that can execute multi-link communication is called an MLD (Multi-Link Device). Particularly, an MLD functioning as an access point (AP) and operating as a role of constructing a network is called an AP MLD, and an MLD functioning as a station (STA) and operating as a role of joining the constructed network is called a Non-AP MLD. In this embodiment, assume that an AP MLD 102 constructs the network 101, establishes links 104 and 105 with a Non-AP MLD 103, and executes multi-link communication. Note that in this embodiment, if the communication apparatuses need not particularly be discriminated, the AP MLD 102 and the Non-AP MLD 103 will collectively be referred to as communication apparatuses hereinafter.

In a plurality of radio links established in multi-link communication, frequency channels in different frequency bands can be used. For example, the AP MLD 102 and the Non-AP MLD 103 can establish the link 105 using the second frequency channel in the 5-GHz band while establishing the link 104 using the first frequency channel in the 2.4-GHz band, and communicate with each other via both the links. In this case, the AP MLD 102 simultaneously maintains the links 104 and 105. When a plurality of links are established between the AP MLD 102 and the Non-AP MLD 103 using a plurality of frequency channels, it is possible to improve throughput in communication between these communication apparatuses. Note that the example in which two links are established has been explained above but three or more links may be established simultaneously. For example, in addition to the link 104 in the 2.4-GHz band and the link 105 in the 5-GHz band, a link (not shown) in the 6-GHz band may be established between the AP MLD 102 and the Non-AP MLD 103.

The AP MLD 102 and the Non-AP MLD 103 may establish, using a plurality of different frequency bands, a plurality of links to perform multi-link communication, as described above, but may establish a plurality of links using different frequency channels in the same frequency band. Note that the plurality of frequency channels used in the plurality of links established between the AP MLD 102 and the Non-AP MLD 103 can be selected from channels having an interval of at least 20 MHz. In one example, the links 104 and 105 may be established using channels 1 and 11 in the 2.4-GHz band between the AP MLD 102 and the Non-AP MLD 103. Two or more of the plurality of links may be established using different frequency channels in the same frequency band, and the remaining links may be established in another frequency band. For example, between the AP MLD 102 and the Non-AP MLD 103, two links can be established using channels 1 and 11 in the 2.4-GHz band and another link can be established using channel 36 in the 5-GHz band. When the plurality of links are established in the different frequency bands between the AP MLD 102 and the Non-AP MLD 103, even if the communication rate in a given frequency band decreases due to a heavy-load state or the like, a predetermined communication rate can be ensured by communication in another frequency band. Therefore, it is possible to suppress a decrease in throughput in communication between these communication apparatuses.

The AP MLD 102 and the Non-AP MLD 103 can execute, for example, MIMO (Multiple-Input Multiple-Output) communication. In this case, each of the AP MLD 102 and the Non-AP MLD 103 includes a plurality of antennas, and the transmission-side communication apparatus simultaneously transmits different signals from the respective antennas using the same frequency channel. The reception-side communication apparatus simultaneously receives all the signals arriving from a plurality of streams using the plurality of antennas, separates the signals of the streams, and decodes them. Thus, the communication apparatuses can communicate many data within a short time. When performing multi-link communication, the AP MLD 102 and the Non-AP MLD 103 can execute MIMO communication in some of the links.

Note that each of the AP MLD 102 and the Non-AP MLD 103 may comply with other communication standards such as Bluetooth®, NFC, UWB, ZigBee®, and MBOA in addition to the IEEE 802.11 series standards. Note that NFC is an abbreviation for Near Field Communication, UWB is an abbreviation for Ultra Wide Band, and MBOA is an abbreviation for Multi Band OFDM Alliance. UWB includes wireless USB, wireless 1394, and WiNET. Each communication apparatus may support communication standards of wired communication such as a wired LAN.

The AP MLD 102 can be, for example, a wireless LAN router, a personal computer (PC), or the like but is not limited to them. Furthermore, the Non-AP MLD 103 can be, for example, a camera, a tablet, a smartphone, a PC, a mobile phone, a video camera, a headset, or the like but is not limited to them. Each of the AP MLD 102 and the Non-AP MLD 103 may be an information processing apparatus such as a radio chip that can execute wireless communication complying with the IEEE802.11be standard.

Note that the wireless network shown in FIG. 1 includes one AP MLD and one Non-AP MLD but the numbers and arrangements of AP MLDs and Non-AP MLDs are not limited to these. For example, in the wireless network shown in FIG. 1, the numbers of AP MLDs and Non-AP MLDs may be increased. Note that in this case, the frequency band of each link to be established, the number of links, and the frequency bandwidth are not particularly limited.

Assume that each communication apparatus according to this embodiment is configured to execute EMLMR (Enhanced Multi-Link Multi-Radio) communication. In EMLMR, spatial streams usable in some of a plurality of links established in multi-link communication are temporarily aggregated to a specific link to increase the number of spatial streams in the link, thereby implementing efficient communication.

In a case where EMLMR is used, as a result of aggregating spatial streams to a specific link, it can be assumed that there are no spatial streams usable in another link. In this case, the communication apparatus may not be able to receive all signals transmitted using the frequency channel of the link in which there are no usable spatial streams. Therefore, for example, the communication apparatus cannot observe, in the frequency channel, an RTS (Request To Send) frame or a CTS (Clear To Send) frame transmitted by another communication apparatus during EMLMR communication. Then, since the communication apparatus cannot receive the RTS frame or the CTS frame, it may not be able to appropriately set a transmission prohibition period (Network Allocation Vector, NAV). Therefore, the communication apparatus may interfere with communication of another communication apparatus after the end of EMLMR communication.

Note that even in a status in which the STA connected to the AP operates in a power saving mode and performs packet transmission immediately after returning from a Doze state, the STA cannot receive the RTS frame or the CTS frame in a power saving state (Doze state). Therefore, the STA does not set a NAV, and undesirably starts to transmit a signal when power detection is performed on the frequency channel and a radio wave cannot be detected. In this case, the signal transmitted by the STA may collide against a signal from another STA that is not observed from the STA. In consideration of this condition, in the IEEE802.11 series standard, a period called “NAVSyncDelay” is defined and it is defined that the STA which has returned from the Doze state starts transmission after standing by for this period. Therefore, the STA does not transmit any signal during a period in which a NAV may be set by the RTS frame or the CTS frame, and it is thus possible to prevent the transmission signal from colliding against a signal from another STA. Such NAVSyncDelay can also be applied in the above-described communication apparatus using EMLMR. However, the application of NAVSyncDelay may lower throughput or deteriorate the frequency use efficiency.

In this embodiment, after completion of transmission/reception of data in the link used for EMLMR communication, the AP MLD 102 notifies the Non-AP MLD 103 whether the frequency channel corresponding to the link not used for EMLMR communication can be used. Note that EMLMR communication indicates communication performed by aggregating spatial streams in some of the plurality of links set as targets of EMLMR. Note that the plurality of links set as targets of EMLMR will sometimes be referred to as EMLMR links hereinafter. In addition, the link used for EMLMR communication indicates an EMLMR link on which communication is performed using the aggregated spatial streams. On the other hand, the link not used for EMLMR communication indicates an EMLMR link in which spatial streams are used in another link and no communication is performed. When the AP MLD 102 notifies the Non-AP MLD 103 that the frequency channel not used for EMLMR communication can be used, the Non-AP MLD 103 can attempt communication using the frequency channel without standing by for the NAVSyncDelay period. Alternatively, when the AP MLD 102 notifies the Non-AP MLD 103 that the frequency channel not used for EMLMR communication cannot be used, the Non-AP MLD 103 can stand by for the NAVSyncDelay period using the frequency channel. Thus, the Non-AP MLD 103 need not unnecessarily stand by for the NAVSyncDelay period in accordance with the status, and can perform communication without interfering with communication of another communication apparatus.

### (Arrangement of Communication Apparatus)

An example of the hardware arrangement of the communication apparatus (the AP MLD 102 and the Non-AP MLD 103) according to this embodiment will be described with reference to FIG. 2. For example, the communication apparatus includes, as its hardware components, a storage unit 201, a control unit 202, a function unit 203, an input unit 204, an output unit 205, a communication unit 206, and an antenna 207.

The storage unit 201 is formed by including one or more memories such as a ROM and a RAM, and stores computer programs for performing various operations (to be described later), and various kinds of information such as communication parameters for wireless communication. Note that the ROM is an abbreviation for Read Only Memory and the RAM is an abbreviation for Random Access Memory. Note that in addition to or instead of the memory such as a ROM or a RAM, the storage unit 201 may include a storage medium such as a flexible disk, a hard disk, an optical disk, a magneto-optical disk, a CD-ROM, a CD-R, a magnetic tape, a nonvolatile memory card, or a DVD. The storage unit 201 may include a plurality of memories.

The control unit 202 is formed by one or more processors such as a CPU and an MPU, and controls the whole communication apparatus by executing, for example, computer programs stored in the storage unit 201. Note that the CPU is an abbreviation for Central Processing Unit, and the MPU is an abbreviation for Micro Processing Unit. The control unit 202 can be configured to execute processing of generating data or a signal to be transmitted in communication with another communication apparatus in addition to control of the whole communication apparatus. Note that the control unit 202 may be configured to, for example, execute processing such as control of the whole communication apparatus by cooperation of computer programs and an OS (Operating System) stored in the storage unit 201. In addition, the control unit 202 may include a plurality of processors such as a multi-core processor, and execute processing such as control of the whole communication apparatus by the plurality of processors. The control unit 202 may be formed from an ASIC (Application-Specific Integrated Circuit), a DSP (Digital Signal Processor), an FPGA (Field Programmable Gate Array), or the like.

In addition, the control unit 202 controls the function unit 203 to execute predetermined processing such as image capturing, printing, or projection. The function unit 203 is, for example, hardware used by the communication apparatus to execute predetermined processing. If, for example, the communication apparatus is a camera, the function unit 203 is an image capturing unit and performs image capturing processing. For example, if the communication apparatus is a printer, the function unit 203 is a print unit and performs print processing. For example, if the communication apparatus is a projector, the function unit 203 is a projection unit and performs projection processing. Data to be processed by the function unit 203 may be data stored in the storage unit 201, or may be data communicated with another communication apparatus via the communication unit 206 to be described later.

The input unit 204 accepts various kinds of operations from the user. The output unit 205 performs various kinds of outputs to the user. In this example, the output by the output unit 205 includes, for example, at least one of display on a screen, audio output by a loudspeaker, and vibration output. Note that both the input unit 204 and the output unit 205 may be implemented by one module, like a touch panel. Furthermore, each of the input unit 204 and the output unit 205 may be incorporated in the communication apparatus, or may be configured as an external apparatus connected to the communication apparatus.

The communication unit 206 controls wireless communication complying with the IEEE 802.11 series standard or controls IP communication. In this embodiment, the communication unit 206 is configured to particularly control wireless communication complying with the IEEE 802.11be standard. Note that in addition to the IEEE 802.11be standard, the communication unit 206 may control wireless communication complying with another IEEE 802.11 series standard or control wired communication by a wired LAN or the like. The communication unit 206 controls the antenna 207 to, for example, transmit/receive signals for wireless communication generated by the control unit 202. The communication apparatus may include a plurality of communication units 206. If the communication apparatus includes the plurality of communication units 206, when establishing a plurality of links in multi-link communication, one link can be established by one communication unit 206. Note that the communication apparatus may establish one link for each of some of the communication units 206, and establish a plurality of links for the remaining communication units 206. Alternatively, when establishing the plurality of links using one communication unit 206, the communication unit 206 can execute communication via the plurality of links by time-divisionally switching the operating frequency channel. Note that if the communication apparatus supports the NFC standard or Bluetooth® standard in addition to the IEEE 802.11be standard, it may control wireless communication complying with these communication standards. If the communication apparatus can execute wireless communication complying with a plurality of communication standards, it may include a communication unit and an antenna supporting each communication standard. The communication apparatus communicates data such as image data, document data, or video data with another communication apparatus via the communication unit 206. Note that the antenna 207 may be prepared separately from the communication unit 206 or may be formed as one module combined with the communication unit 206.

The antenna 207 is an antenna configured to allow communication in various frequency bands such as sub-GHz band, the 2.4-GHz band, the 5-GHz band, the 6-GHz band, and 60-GHz band. Note that the communication apparatus may include, as the antenna 207, one antenna such as a multiband antenna or a plurality of antennas respectively corresponding to the plurality of frequency bands. If the communication apparatus includes a plurality of antennas, it may include one communication unit 206 for the plurality of antennas or a plurality of communication units 206 respectively corresponding to the plurality of antennas. Note that the antenna 207 may be a single antenna or an antenna array. That is, the antenna 207 may include a plurality of antenna elements, and may be configured to execute, for example, MIMO (Multi-Input and Multi-Output) communication.

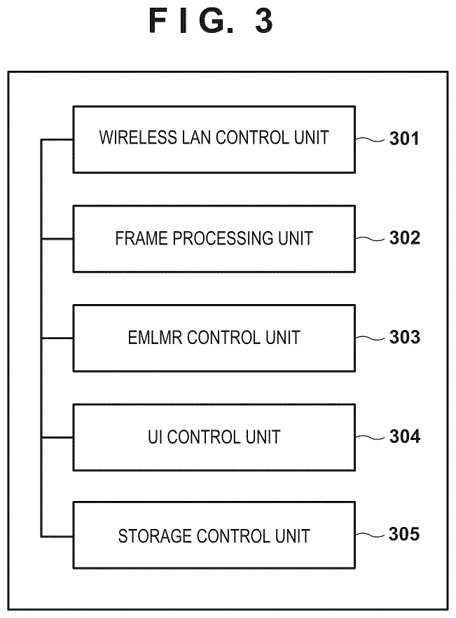

Subsequently, an example of the functional arrangement of the communication apparatus according to this embodiment will be described with reference to FIG. 3. The communication apparatus (the AP MLD 102 and the Non-AP MLD 103) includes, for example, a wireless LAN control unit 301, a frame processing unit 302, an EMLMR control unit 303, a UI control unit 304, and a storage control unit 305. Note that these are merely examples, and some or all of the function units may be replaced by other components, a plurality of function units may be integrated to form one function unit, and one function unit may be divided into a plurality of function units. A plurality of identical function units may be prepared. For example, a plurality of wireless LAN control units 301 may be provided.

The wireless LAN control unit 301 controls the antenna 207 and a communication circuit (for example, the communication unit 206) to transmit/receive radio signals to/from another wireless LAN communication apparatus. The frame processing unit 302 executes processing of radio frames transmitted/received by the wireless LAN control unit 301. In accordance with the IEEE 802.11 series standard, the frame processing unit 302 generates a radio frame including control information and content data, and transfers it to the wireless LAN control unit 301. Then, the wireless LAN control unit 301 executes predetermined wireless processing such as frequency conversion for the generated radio frame, and transmits the thus obtained radio frame to another communication apparatus. Furthermore, the wireless LAN control unit 301 receives a radio frame transmitted by another communication apparatus via the antenna, executes predetermined wireless processing for the radio frame, and transfers the thus obtained radio frame to the frame processing unit 302. The frame processing unit 302 analyzes the contents of the received radio frame to acquire control information and content data. The control information generated by the frame processing unit 302 or the control information acquired by the frame processing unit 302 based on the radio frame from another communication apparatus may be restricted by settings stored in the storage unit 201. This control information may be changed by user settings from the UI control unit 304.

The EMLMR control unit 303 performs management control of determining which of a plurality of links established with another communication apparatus are set as EMLMR links. The management control includes establishment of an EMLMR link and deletion of an EMLMR link. An EMLMR link is established by specifying the EMLMR link at the time of establishment of a multi-link or after establishment of a multi-link. When the specification of a link specified as an EMLMR link is canceled, the EMLRM link is deleted.

The UI control unit 304 controls hardware associated with a user interface such as a touch panel or buttons for accepting an operation of the communication apparatus by a user (not shown). Note that the UI control unit 304 also executes control to present information to the user, such as display of an image and the like or audio output. The storage control unit 305 executes control to store, in the storage unit 201, programs and data for operating the communication apparatus, and read them out from the storage unit 201.

### (Overview of Multi-Link Communication)

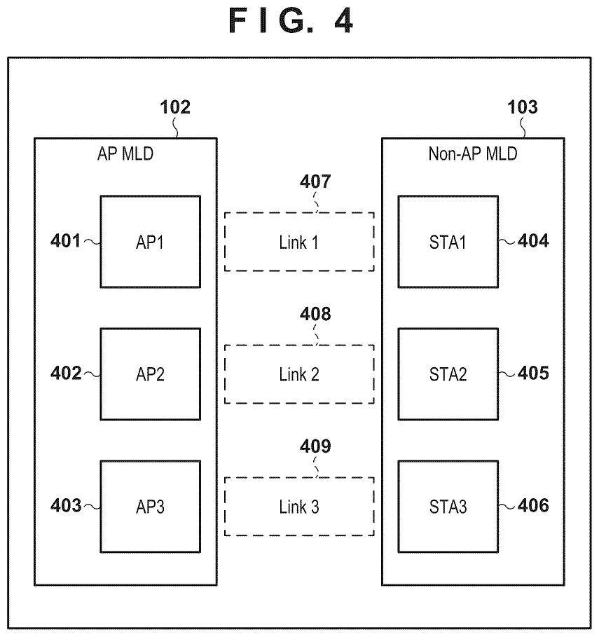

Multi-link communication will generally be described with reference to FIG. 4. Each of the AP MLD 102 and the Non-AP MLD 103 includes a plurality of (physical or logical) APs or STAs each associated with a plurality of links. Referring to FIG. 4, for example, the AP MLD 102 includes first to third APs 401 to 403, and the Non-AP MLD 103 includes first to third STAs 404 to 406. The first AP 401 and the first STA 404 establish a first link 407 using the first frequency channel. Similarly, the second AP 402 and the second STA 405 establish a second link 408 using the second frequency channel, and the third AP 403 and the third STA 406 establish a third link 409 using the third frequency channel. Note that each of the first to third frequency channels is, for example, a frequency channel in one of the sub-GHz band, the 2.4-GHz band, 3.6-GHz band, 4.9-GHz band, the 5-GHz band, the 6-GHz band, and 60-GHz band. Note that the first link 407, the second link 408, and the third link 409 will be referred to as link 1, link 2, and link 3, respectively, hereinafter.

Each of links 1 to 3 is assigned with the number of spatial streams in accordance with per-link spatial stream capability. The per-link spatial stream capability indicates, for example, the number of usable spatial streams in each link. For example, in a link with per-link spatial stream capability of “2”, two spatial streams can be set. The communication apparatus can perform spatial division within the range of the spatial stream capability, and simultaneously transmit a plurality of data streams in the same frequency band at the same timing not to cause spatial interference. In an example, when there are six antennas and three links are established, each link can be set as a link using two antennas. In this case, the spatial stream capability of each link is “2”. When two of links 1 to 3 are specified as E-LMR links, the spatial stream capability of one of the links on which an EMLMR operation is performed is “4”. When all links 1 to 3 are specified as EMLMR links, the spatial steam capability of one link on which communication is executed by an EMLMR operation is “6”. On the other hand, when the EMLMR operation is executed in one link, the spatial steam capability of each of the remaining EMLMR links is “0”. For example, if links 1 and 2 are set as EMLMR links, when the EMLMR operation is executed on link 1, the spatial stream capability of link 1 is “4” and the spatial stream capability of link 2 is “0”. By using EMLMR, it is possible to temporarily increase the spatial stream capability of a specific link, it is possible to perform high-speed and large-capacity communication in the link.

Note that “EMLMR operation” indicates performing communication using the mechanism of EMLMR. That is, the EMLMR operation is performed in a link, among the EMLMR links, in which the spatial stream capability is increased to perform communication. On the other hand, the spatial stream capability of an EMLMR link is used by another EMLMR link in accordance with the mechanism of EMLMR when the EMLMR operation is executed in the other EMLMR link. That is, it can be said that this link also operates in accordance with EMLMR but this operation is not called an EMLMR operation.

Note that the number of spatial streams can be decided by an EHT Capabilities element or an EHT Operation element included in a frame used by the Non-AP MLD to declare to the AP MLD that it supports EHT. For example, the number of spatial streams can be decided based on the value of a Supported EHT-MCS And NSS Set field included in the EHT Capabilities element or the EHT Operation element. Alternatively, the number of spatial streams may be decided based on the value of a Basic EHT-MCS And NSS Set field included in each of these information elements.

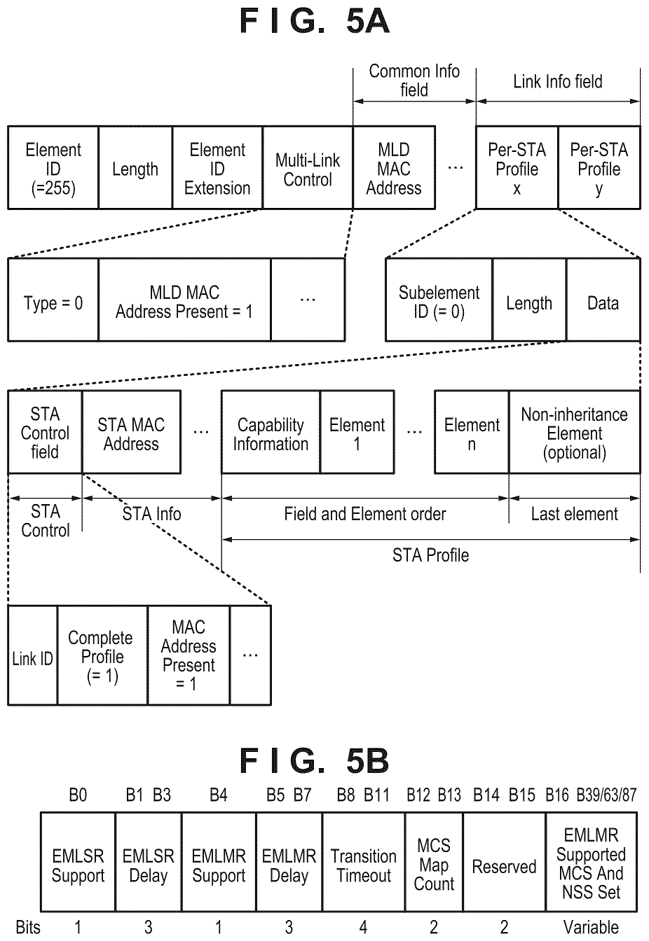

The information element used to set EMLMR will now be described. FIG. 5A shows a Basic variant Multi-Link element in an Association Request frame. As an example, this Basic variant Multi-Link element can be included in an Association Request frame when establishing a Multi-Link. Note that the present invention is not limited to this, and this information may be included in, for example, a Probe request frame, a Probe response frame, an Association response frame, a Beacon frame, or the like. In FIG. 5A, the values of an Element ID field and an Element ID Extension field indicate that this information element is a Basic variant Multi-Link element. A Length field indicates the length of the information element. A Multi-Link Control field stores multi-link-related control information. This field will not be described in detail here. A Common Info field storing common information for one or more STAs is arranged following the Multi-Link Control field. This Common Info field includes EMLMR Capabilities subfields, as shown in FIG. 5B. Following this field, a Link Info field storing a Per-STA Profile is arranged. This field will not be described in detail here.

When an EMLMR Support subfield among the EMLMR Capabilities subfields in FIG. 5B is set to “0”, this indicates that the transmitter of this information does not support EMLMR. On the other hand, when this field is set to “1”, this indicates that the transmitter of this information supports EMLMR. By transmitting/receiving or exchanging a frame including the EMLMR Support subfield set with a value of “1”, each link forming the multi-link can be set as an EMLMR link.

Note that by transmitting/receiving or exchanging the information only in some of the links forming the multi-link, EMLMR links can be established only for the some links. By transmitting/receiving or exchanging the frame including the EMLMR Support subfield set with a value of “1” in one link, EMLMR links may be established for a plurality of links including the remaining links. In this case, EMLMR links may be established for all the links forming the multi-link or only for some links. When designating a link for which an EMLMR link is established, information for identifying the link for which the EMLMR link is established can be included in a frame including the EMLMR Support subfield set with a value of “1”. This designates the link for which the EMLMR link should be established. The information for identifying the link can be a link identifier, a BSSID (Basic Service Set IDentifier) corresponding to the link, a TID (Traffic IDentifier), or the like.

Among the EMLMR Capabilities subfields shown in FIG. 5B, an EMLMR Supported MCS And NSS Set subfield stores the maximum number of spatial streams when transmitting/receiving a PPDU during the EMLMR operation. When a specific link of the EMLMR links executes the EMLMR operation, the number of spatial streams assigned to the EMLMR links other than the specific link decreases, and the specific EMLMR link can transmit/receive a PPDU with the increased number of spatial streams.

Note that a case where an instruction is sent to establish EMLMR links when establishing a multi-link has been described above. However, an Action frame transmitted after establishing a multi-link may be used to designate establishment of EMLMR links. To do this, for example, a frame called an EML (Enhanced Multi-Link) Operating Mode Notification frame can be used. For example, the AP MLD transmits the frame including the EMLMR Support subfield set with a value of “1”, and the Non-AP MLD receives this frame. Then, the Non-AP MLD transmits an EML Operating Mode Notification frame including an EMLMR Mode subfield set with a value of “1”, and the AP MLD receives this frame. This can set, as an EMLMR link, a link used to transmit/receive these frames. Some or all of the remaining links forming the multi-link, on which these frames are not transmitted/received, may be set as EMLMR links. In a case where some links are set as EMLMR links, information for identifying a link specified as an EMLMR link can be included in the EML Operating Mode Notification frame. Similar to the above-described case, a link identifier, a BSSID, a TID, or the like can be used as the information for identifying the link.

Note that the example in which the Non-AP MLD leads to establish an EMLMR link has been explained. However, the AP MLD may instruct to establish an EMLMR link. Note that the EML Operating Mode Notification frame is an Action frame to be transmitted so that the Non-AP MLD operates in an EMLMR mode. If the Non-AP MLD does not establish an EMLMR link when establishing multi-link communication, and establishes an EMLMR link thereafter, it transmits the EML Operating Mode Notification frame. Furthermore, if, after setting the EMLMR link, the link is deleted from the EMLMR link, the EML Operating Mode Notification frame is transmitted to operate the link in the EMLMR mode again.

### (Procedure of Communication)

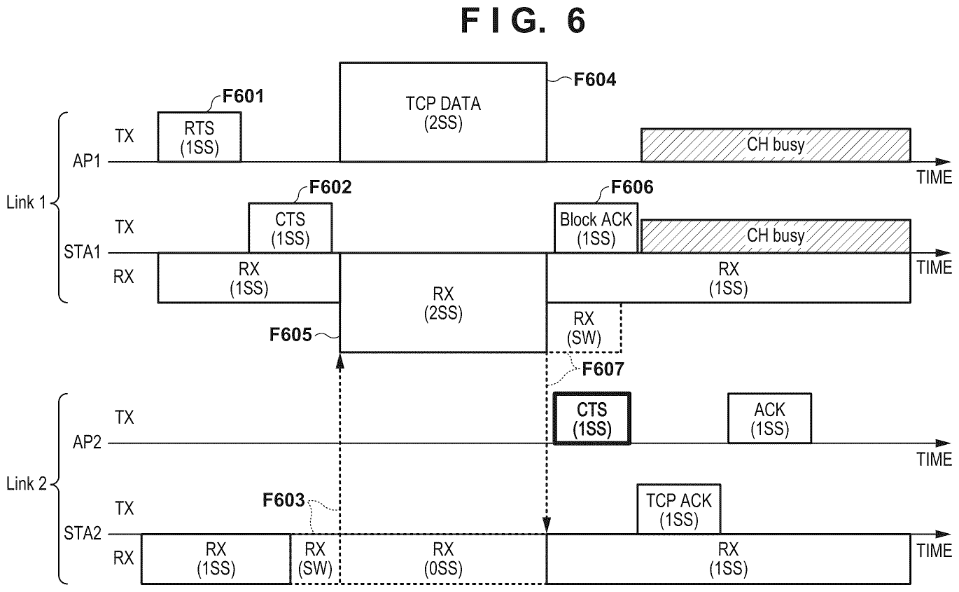

Subsequently, an example of the procedure of communication (frame exchange sequence) executed in this embodiment will be described with reference to FIG. 6. The procedure of communication in a case where the AP MLD 102 transmits data to the Non-AP MLD 103 will be described as an example. Note that the AP MLD 102 sets links 1 and 2 in FIG. 4 as EMLMR links. For the sake of descriptive convenience, assume that the spatial stream capability of each link when the EMLMR operation is not executed is “1” and the spatial stream capability of a link on which the EMLMR operation is executed is “2”. Note that in FIG. 6, AP functions used by the AP MLD 102 in the frequency channels of links 1 and 2 are represented by “AP1” and “AP2”. In addition, STA functions used by the Non-AP MLD 103 in the frequency channels of links 1 and 2 are represented by “STA1” and “STA2”.

In FIG. 6, time progresses from left to right, and radio frames transmitted/received in each link are shown along the time progress. Note that with respect to the AP functions, only a communication state on the transmission side (TX) is shown, and with respect to the STA functions, a communication state on the transmission side (TX) is shown on the upper side of the time axis and a communication state on the reception side (RX) is shown on the lower side of the time axis. Note that as an example, on the AP MLD 102, one or more reception functions always operate in either of the links even during the EMLMR operation, and the spatial stream capability is always equal to or larger than that of the Non-AP MLD 103. For example, assume that the spatial stream capability of the AP MLD 102 is “2” for both links 1 and 2. In this case, even if the Non-AP MLD 103 executes the EMLMR operation, the AP MLD 102 need not change the spatial stream capability.

Note that “SS” of a radio frame on the transmission side represents a spatial stream used to transmit a signal. For example, a radio frame of “2SS” is transmitted using two spatial streams. In addition, “SS” indicated on the reception side represents the number of spatial streams that can be received. For example, during a section in which “2SS” is indicated on the reception side, two spatial streams can be received. Note that a period during which 2SS can be used is indicated by setting the height of a block large. During a section represented by broken lines on the reception side, the E-LMR operation is executed in another link, the number of usable spatial streams is zero, and reception is thus impossible. Note that a period during which “RX SW” is indicated on the reception side is a period necessary for the reception function to change the setting to move between the links and to be reactivated, that is, a switching period.

Assume that the AP MLD 102 transmits, to the Non-AP MLD 103, a data frame by setting “2” as the spatial streams in the E-LMR mode on link 1. In this case, the AP MLD 102 first transmits an RTS (Request To Send) frame including information necessary for the EMLMR operation (F601). With this RTS frame, the Non-AP MLD 103 can recognize that the EMLMR operation is started. Upon receiving the RTS frame, the Non-AP MILD 103 transmits a CTS (Clear To Send) frame to the AP MLD 102 as a response to the RTS frame in a case where the EMLMR operation can be executed (F602). The Non-AP MLD 103 notifies, by this CTS frame, the AP MLD 102 that it can receive the data frame set with “2” as the spatial streams by the EMLMR operation. Furthermore, the Non-AP MLD 103 can notify, of a NAV, another communication apparatus on the periphery that uses the same frequency channel. Furthermore, the Non-AP MLD 103 moves the reception function on link 2 to link 1, sets 2 as the number of reception spatial streams on link 1, and sets 0 as the number of reception spatial streams on link 2 (F603). Since the Non-AP MLD 103 starts transmission by setting “2” as the number of spatial streams after the SIFS period elapses since the completion of the transmission of the CTS frame on link 1, the Non-AP MLD 103 operates to complete the movement of the reception function before that.

After the SIFS period elapses since the reception of the CTS frame, the AP MLD 102 starts to transmit a data frame by setting “2” as the spatial streams (F604). FIG. 6 shows an example in which the data frame is transmitted immediately after the CTS frame. However, before transmitting the data frame, a procedure of transmitting a sounding packet from the Non-AP MLD 103 or the AP MLD 102 may be added.

Upon completion of the reception of the data frame set with “2” as the number of spatial frames (F605), the Non-AP MLD 103 transmits a Block Ack as a response to the received data frame after the SIFS period elapses (F606). Furthermore, the Non-AP MLD 103 returns the reception function aggregated on link 1 to link 2 (F607). This returns the Non-AP MLD 103 to the state before the EMLMR operation is started.

Before restarting the reception operation on link 2, even if another STA or AP sets a NAV on link 2, the Non-AP MLD 103 cannot recognize it. Therefore, in an example, the Non-AP MLD 103 stands by for transmission for the NAVSyncDelay period after restarting the reception operation on link 2, and monitors the use status of the frequency channel. When the Non-AP MLD 103 detects that another communication apparatus newly sets a NAV before the end of the period, it can stop standing by for transmission, and perform a normal operation in accordance with the newly set NAV On the other hand, when no NAV is newly set, the Non-AP MLD 103 performs a normal operation after the NAVSyncDelay period expires. Thus, when the Non-AP MLD 103 transmits a signal on link 2, the probability that the signal collides against a transmission signal transmitted by another communication apparatus can be reduced. On the other hand, when the frequency channel is not congested, it is assumed that such collision does not occur even if the Non-AP MLD 103 does not stand by for the NAVSyncDelay period. That is, if the Non-AP MLD 103 stands by for transmission for the NAVSyncDelay period, it is impossible to improve communication throughput accordingly.

However, the Non-AP MLD 103 cannot independently recognize whether another communication apparatus sets a NAV, immediately after restarting the reception operation on link 2. On the other hand, the AP MLD 102 always performs the reception operation on link 2 even while EMLMR communication is performed. Therefore, the AP MLD 102 can recognize whether a NAV is set. Therefore, in this embodiment, the AP MLD 102 can make a notification to the Non-AP MLD 103 in correspondence with the setting status of the NAV on link 2. The AP MLD 102 can newly set a NAV in accordance with the setting status of the NAV on link 2, and make a notification. Thus, for example, the AP MLD 102 can make the Non-AP MLD 103 stand by for a period of a length corresponding to the setting status of the NAV That is, when no NAV is set on link 2, the AP MLD 102 makes a notification to allow the Non-AP MLD 103 to transmit a signal on link 2 before standing by for the NAVSyncDelay period. In an example, the AP MLD 102 can transmit a CTS frame destined for the Non-AP MLD 103 so that the Non-AP MLD 103 can transmit a signal on link 2. With this CTS frame, the AP MLD 102 can set a NAV on link 2, and the Non-AP MLD 103 can transmit data on link 2 without standing by for the NAVSyncDelay period. That is, by setting the destination of the CTS frame to the Non-AP MLD 103, the Non-AP MLD 103 can transmit data after transmitting/receiving the CTS frame.

From a timing at which the Non-AP MLD 103 is assumed to restart the reception operation on link 2, during a period from when the reception operation is restarted until the end of the NAVSyncDelay period, this CTS frame is transmitted. Since the Non-AP MLD 103 can execute a normal transmission operation on link 2 after the NAVSyncDelay period elapses, the AP MLD 102 need not perform any special action. Furthermore, when another communication apparatus makes a notification of a new NAV, the AP MLD 102 need not transmit this CTS frame.

For example, the AP MLD 102 may notify the Non-AP MLD 103 of information indicating whether a NAV is set. For example, when no NAV is set, the Non-AP MLD 103 does not stand by for the NAVSyncDelay period, and when a NAV is set, the Non-AP MLD 103 can stand by for the NAVSyncDelay period. In addition, when a NAV is set, the Non-AP MLD 103 may be notified of information for designating the NAV period and may stand by for the period.

In an example, the Non-AP MLD 103 can notify, on link 1, the AP MLD 102 of buffer status information on link 2 during the EMLMR operation. When the Non-AP MLD 103 has data to be transmitted on link 2, the AP MLD 102 can transmit the CTS frame to cause the Non-AP MLD 103 to transmit the data. If, after the completion of communication in the EMLMR operation, another communication apparatus uses link 1, and the AP MLD 102 cannot perform transmission/reception on link 1, the AP MLD 102 may transmit the CTS frame. When, for example, the data frame is a TCP packet, the AP MLD 102 can predict that the Non-AP MLD 103 transmits a response of a TCP Ack. Therefore, the AP MLD 102 can appropriately set, in accordance with the TCP Ack, the NAV period set by the CTS frame.

Note that when the Non-AP MLD 103 has no data to be transmitted on link 2, the AP MLD 102 can notify the Non-AP MLD 103 only whether a NAV is set. In a case where the AP MLD 102 transmits data using the frequency channel of link 2, the AP MLD 102 can also transmit the data while the Non-AP MLD 103 stands by for the NAVSyncDelay period. Thus, when no NAV is set on link 2 and the Non-AP MLD 103 should transmit data on link 2, the Non-AP MLD 103 can obtain a transmission opportunity earlier than in a case where the Non-AP MLD 103 stands by for the NAVSyncDelay period.

### (Processing of AP MLD 102)

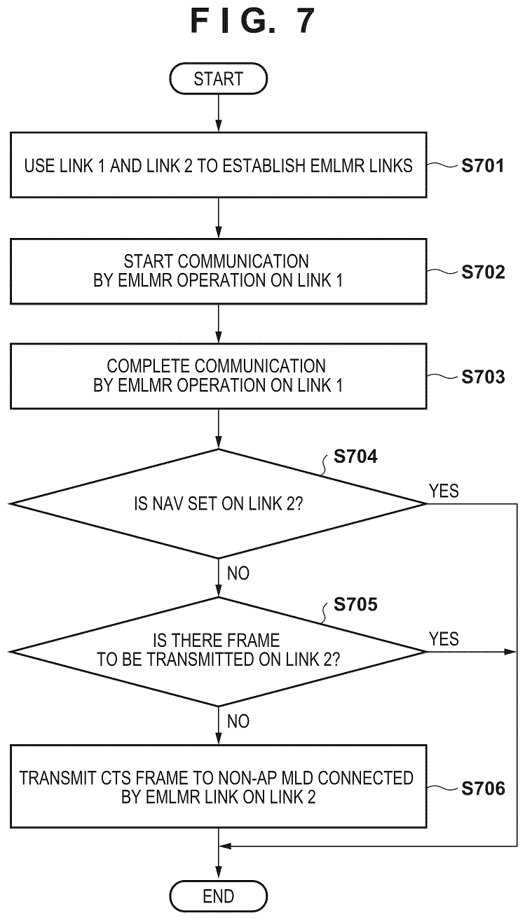

FIG. 7 shows an example of the procedure of processing executed by the AP MLD 102. This processing can be implemented when, for example, the control unit 202 of the AP MLD 102 executes a program stored in the storage unit 201. Note that dedicated hardware provided in the AP MLD 102 may execute at least some of processes to be described below.

In this processing, first, the AP MLD 102 executes setting processing of applying EMLMR to two or more links with the Non-AP MLD 103, thereby establishing EMLMR links (step S701). Note that some of a plurality of links established between the AP MLD 102 and the Non-AP MLD 103 may be selected as two or more EMLMR links applied with the above-described EMLMR, or all the plurality of links may be selected as EMLMR links. In this example, as described with reference to FIG. 6, assume that two links of link 1 and link 2 are set as EMLMR links.

The AP MLD 102 starts communication with the Non-AP MLD 103 by the EMLMR operation starting from the RTS frame, as described above, and executes communication by the EMLMR operation until the communication is completed (steps S702 and S703). While the EMLMR operation is executed, all the reception functions of the Non-AP MLD 103 are used on link 1 for the EMLMR operation. Therefore, even if another communication apparatus makes a notification of a NAV on link 2, the Non-AP MLD 103 cannot receive it. Thus, the AP MLD 102 executes monitoring to specify the setting status of the NAV on link 2 during the EMLMR operation. Then, after the completion of the EMLMR operation, the AP MLD 102 decides, based on, for example, the setting status of the NAV on link 2 and the presence/absence of a frame to be transmitted by the AP MLD 102, whether to transmit a CTS frame to the Non-AP MLD 103.

For example, if a NAV is set on link 2 while the Non-AP MLD 103 executes the EMLMR operation on link 1 (YES in step S704), the AP MLD 102 does nothing. This causes the Non-AP MLD 103 to stand by for the NAVSyncDelay period and then transmit a frame. Note that if the set NAV period expires before the NAVSyncDelay period expires, the AP MLD 102 may transmit a predetermined notification to the Non-AP MLD 103 to cancel the standby state. If the AP MLD 102 has a frame to be transmitted on link 2 (YES in step S705), the AP MLD 102 transmits the frame and does nothing for the Non-AP MLD 103. This causes the Non-AP MLD 103 to stand by for the NAVSyncDelay period and then transmit a frame. Note that if the frame transmission of the self-apparatus is complete before the NAVSyncDelay period expires, the AP MLD 102 may transmit a predetermined notification to the Non-AP MLD 103 to cancel the standby state.

On the other hand, when no NAV is set on link 2 and the AP MLD 102 has no frame to be transmitted on link 2 (NO in steps S704 and S705), the AP MLD 102 transmits a CTS frame destined for the Non-AP MLD 103 (step S706). Note that at a timing after the Non-AP MLD 103 completes the EMLMR operation on link 1 and restarts the reception operation on link 2, the AP MLD 102 transmits the CTS frame. This can prevent the CTS frame from being transmitted at a timing when the Non-AP MLD 103 has not started the reception operation on link 2, thereby enabling the Non-AP MLD 103 to reliably detect the CTS frame.

Note that the AP MLD 102 determines whether the Non-AP MLD 103 can receive data on link 2 during EMLMR communication. Only when the Non-AP MLD 103 cannot receive data, the processes of steps S704 to S706 may be executed. That is, only when the Non-AP MLD 103 cannot recognize a status in which another communication apparatus on the periphery sets a NAV, the notification processing in step S706 and the like may be performed.

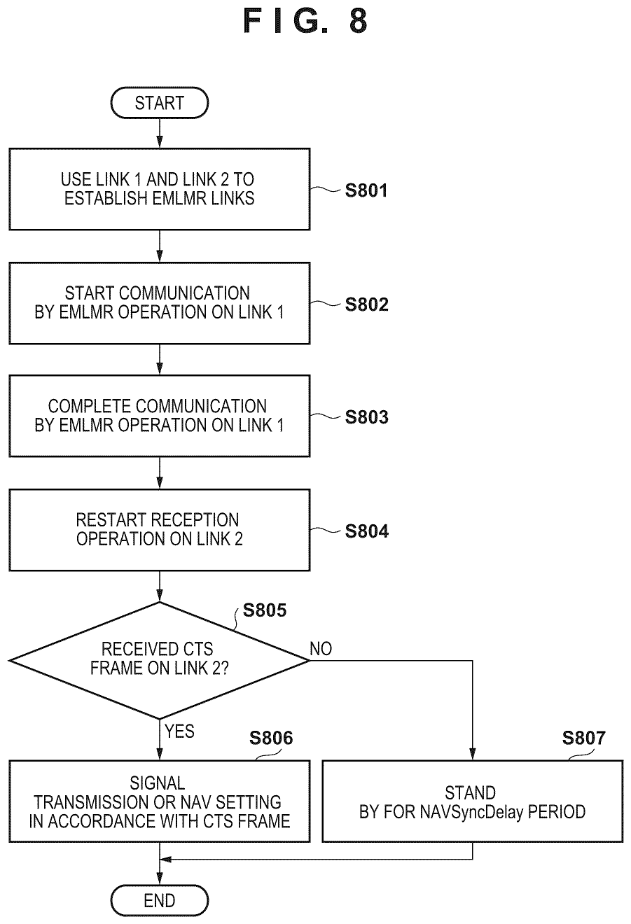

FIG. 8 shows an example of the procedure of processing executed by the Non-AP MLD 103. This processing can be implemented when, for example, the control unit 202 of the Non-AP MLD 103 executes a program stored in the storage unit 201. Note that dedicated hardware provided in the Non-AP MLD 103 may execute at least some of processes to be described below.

Steps S801 to S803 correspond to steps S701 to S703. That is, the Non-AP MLD 103 executes setting processing of applying EMLMR to two or more links with the AP MLD 102, thereby establishing EMLMR links (step S801). In this example, as described with reference to FIG. 6, assume that two links of link 1 and link 2 are set as EMLMR links. The Non-AP MLD 103 starts communication with the AP MLD 102 by the EMLMR operation starting from reception of the RTS frame on link 1, as described above, and executes communication by the EMLMR operation until the communication is completed (steps S802 and S803). After the completion of the communication on link 1 by the EMLMR operation, the Non-AP MLD 103 restarts the reception operation on link 2 (step S804).

After that, when the Non-AP MLD 103 receives the CTS frame on link 2 (YES in step S805), it transmits a signal or sets a NAV in accordance with the CTS frame (step S806). For example, if the Non-AP MLD 103 receives the CTS frame destined for the self-apparatus and there exists a frame to be transmitted, the Non-AP MLD 103 transmits the frame after the completion of the reception of the CTS frame. On the other hand, even if the Non-AP MLD 103 receives the CTS frame destined for the self-apparatus, when there is no frame to be transmitted, the Non-AP MLD 103 can end the processing without performing a transmission operation. Alternatively, if the Non-AP MLD 103 receives the CTS frame not destined for the self-apparatus from a communication apparatus (AP MLD 102 or another communication apparatus), it can set a NAV in accordance with the CTS frame. In this case, even when the Non-AP MLD 103 holds a frame to be transmitted on link 2, it stands by until the NAV period expires without transmitting the frame. On the other hand, if the Non-AP MLD 103 does not receive the CTS frame on link 2 (NO in step S805), it stands by for transmission for the NAVSyncDelay period (step S807). Thus, when, for example, the Non-AP MLD 103 does not receive the CTS frame destined for the self-apparatus from the AP MLD 102, it stands by for a predetermined time, and can then transmit a radio frame.

Note that instead of the CTS frame, an arbitrary procedure of allowing the Non-AP MLD 103 to confirm that another communication apparatus sets no NAV when restarting the reception operation on link 2 may be used. For example, the AP MLD 102 may transmit a null data packet as a zero-length data frame or the like instead of the CTS frame, and notify the Non-AP MLD 103 that no NAV is set on link 2. Furthermore, in a case where the CTS frame is used, it is unnecessary to set a transmission right in the Non-AP MLD 103. The CTS frame destined for the Non-AP MLD 103 may be transmitting by making the length of the NAV period shortest. That is, the Non-AP MLD 103 can be given a transmission opportunity that is short to the extent that it is used to transmit a TCP Ack. In a case where such short NAV is set, when there is no transmission data in the Non-AP MLD 103, it is possible to prevent the frequency channel from being unnecessarily occupied. Note that the RTS frame may be used instead of the CTS frame. Furthermore, link 1 on which EMLMR communication was executed may be used to make a notification of the status of the NAV on link 2 for which the reception operation is restarted.

The example in which the AP MLD 102 makes a notification to the Non-AP MLD 103 has been explained but the present invention is not limited to this. For example, when the Non-AP MLD 103 can receive a signal transmitted from another communication apparatus on the periphery on link 2 while the EMLMR operation is executed on link 1, the Non-AP MLD 103 may execute the above-described processing of the AP MLD 102. The AP MLD 102 and the Non-AP MLD 103 may notify each other of information concerning the NAV set by another communication apparatus on the periphery. That is, a communication apparatus that can receive, at least during EMLMR communication, a signal from another communication apparatus with respect to a link that is not used for the communication may execute the same processing as that of the AP MLD 102. That is, this communication apparatus notifies another communication apparatus of the communication status of the link that is not used for the EMLMR communication. Thus, when the partner apparatus of the EMLMR communication cannot perform the reception operation in the link during the EMLMR operation, the communication apparatus can notify the partner apparatus of the communication status of the link and make the partner apparatus set the NAV, as needed.

Note that even in multi-link communication other than EMLMR communication in which usable spatial streams are aggregated from some links to another link to perform communication, the above-described processing can be applied. That is, by aggregating spatial streams (or antennas) usable in a plurality of links to one link and using them, the above-described processing can be applied in a case where there exists a communication apparatus that cannot receive a signal in another link.

As described above, according to this embodiment, when restarting the reception operation in the EMLMR link that was not used in the EMLMR operation, the communication apparatus can start data transmission within a period shorter than in a case where the apparatus stands by for the NAVSyncDelay period. Note that the example in which the notification from the AP MLD 102 to the Non-AP MLD 103 is controlled in accordance with the information concerning the setting status of the NAV on link 2 has been explained above but the present invention is not limited to this. For example, the communication status including conditions for transmitting a signal, such as the limitation of transmission power on link 2 and the limitation of the number of transmission streams, may be specified, and a notification of information of the specified communication status may be made. For example, the AP MLD 102 specifies the communication status by monitoring whether signal transmission on link 2 is restricted during EMLMR communication with the Non-AP MLD 103 on link 1. Then, when the communication status is continued after the end of the EMLMR communication, the AP MLD 102 can notify the Non-AP MLD 103 of information (that is, a condition under which signal transmission is allowed) indicating the communication status. The notification of the information may be performed, for example, using link 1 during the E-LMR communication or using link 1 or link 2 after the EMLMR communication. In an example, only when no NAV is set, a notification of information concerning the condition under which signal transmission is allowed can be performed. That is, when a NAV is set, the communication apparatus is made to stand by for the NAVSyncDelay period without making a notification or the CTS frame for setting the NAV can be transmitted at least before the NAV expires. On the other hand, when no NAV is set and signal transmission can be executed but is restricted, a notification of the restriction can be performed. Note that when it is known that the partner apparatus cannot cope with the restriction, no notification may be made. This avoids a situation in which the communication apparatus unnecessarily stands by for signal transmission in a signal transmittable status, thereby improving communication efficiency.

According to the present invention, it is possible to perform efficient communication using a plurality of spatial streams.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus for performing communication in accordance with an IEEE 802.11 series standard, comprising:
a communication unit configured to execute predetermined communication with a partner apparatus of the communication by aggregating spatial streams usable by the partner apparatus in each of a plurality of links to a first link among the plurality of links;
a specifying unit configured to specify a communication status in a second link different from the first link among the plurality of links while the predetermined communication is executed in the first link; and
a notification unit configured to transmit a predetermined notification to the partner apparatus based on a fact that the communication status in which the partner apparatus can transmit a signal in the second link is specified at an end of the predetermined communication in the first link.

2. The communication apparatus according to claim 1, wherein
the specifying unit specifies, as the communication status, whether signal transmission is prohibited in the second link, and
in a case where signal transmission is not prohibited in the second link at the end of the predetermined communication in the first link, the notification unit transmits the predetermined notification to the partner apparatus.

3. The communication apparatus according to claim 2, wherein in a case where signal transmission is prohibited in the second link at the end of the predetermined communication in the first link and a case where a first period during which the signal transmission is prohibited does not exceed a second period during which the partner apparatus transmits no signal when the predetermined notification is not transmitted, the notification unit transmits, to the partner apparatus, a notification for prohibiting the signal transmission until the first period expires.

4. The communication apparatus according to claim 3, wherein the notification for prohibiting the signal transmission until the first period expires is a CTS (Clear To Send) frame not destined for the partner apparatus.

5. The communication apparatus according to claim 2, wherein the predetermined notification is a CTS (Clear To Send) frame destined for the partner apparatus.

6. The communication apparatus according to claim 5, wherein a shortest Network Allocation Vector is set in the CTS frame destined for the partner apparatus.

7. The communication apparatus according to claim 2, wherein the predetermined notification is a null data packet.

8. The communication apparatus according to claim 1, wherein
the specifying unit specifies, as the communication status, a condition under which signal transmission in the second link is allowed, and
in a case where there is the condition under which the signal transmission is allowed in the second link, the notification unit transmits the condition as the predetermined notification to the partner apparatus.

9. The communication apparatus according to claim 8, wherein
the specifying unit further specifies, as the communication status, whether the signal transmission is prohibited in the second link, and
in a case where the signal transmission is not prohibited in the second link at the end of the predetermined communication in the first link and there is the condition under which the signal transmission is allowed in the second link, the notification unit transmits the condition as the predetermined notification to the partner apparatus.

10. The communication apparatus according to claim 1, wherein the notification unit transmits the predetermined notification in the first link.

11. The communication apparatus according to claim 1, wherein at a timing when the partner apparatus can receive a signal in the second link after the end of the predetermined communication in the first link, the notification unit transmits the predetermined notification in the second link.

12. The communication apparatus according to claim 1, further comprising a determination unit configured to determine whether the partner apparatus can receive a signal in the second link while performing the predetermined communication,
wherein in a case where the partner apparatus cannot receive a signal in the second link while performing the predetermined communication, the notification unit transmits a predetermined notification to the partner apparatus based on a fact that the communication status in which the partner apparatus can transmit a signal in the second link is specified at the end of the predetermined communication in the first link.

13. The communication apparatus according to claim 1, wherein the predetermined communication is communication using EMLMR (Enhanced Multi-Link Multi-Radio).

14. A communication apparatus operating as an MLD (Multi-Link Device) defined in an IEEE 802.11 series standard, comprising:
a communication unit configured to set, at a start of a frame exchange sequence in an EMLMR (Enhanced Multi-Link Multi-Radio) operation in a first link among a plurality of links established with a partner apparatus, a Network Allocation Vector in another link on which the EMLMR operation is not executed.

15. A control method performed by a communication apparatus that performs communication in accordance with an IEEE 802.11 series standard, the method comprising:
executing predetermined communication with a partner apparatus of the communication by aggregating spatial streams usable by the partner apparatus in each of a plurality of links to a first link among the plurality of links;
specifying a communication status in a second link different from the first link among the plurality of links while the predetermined communication is executed in the first link; and
transmitting a predetermined notification to the partner apparatus based on a fact that the communication status in which the partner apparatus can transmit a signal in the second link is specified at an end of the predetermined communication in the first link.

16. A non-transitory computer-readable storage medium that stores a program for causing a computer included in a communication apparatus, which performs communication in accordance with an IEEE 802.11 series standard, to:
execute predetermined communication with a partner apparatus of the communication by aggregating spatial streams usable by the partner apparatus in each of a plurality of links to a first link among the plurality of links;
specify a communication status in a second link different from the first link among the plurality of links while the predetermined communication is executed in the first link; and
transmit a predetermined notification to the partner apparatus based on a fact that the communication status in which the partner apparatus can transmit a signal in the second link is specified at an end of the predetermined communication in the first link.
